(19) United States
(12) Patent Application Publication
(10) Pub. No.: US 2010/0330526 A1
(43) Pub. Date: Dec. 30, 2010

(54) FILLING MATERIAL PIN FOR A ROOT CANAL OF A TOOTH

(75) Inventors: Adolf Pfaff, Waldkirch (DE); Karl-Friedrich Reichenbach, Waldkirch (DE)

Correspondence Address: VOLPE AND KOENIG, P.C., UNITED PLAZA, 30 SOUTH 17TH STREET, PHILADELPHIA, PA, 19103, US

(73) Assignees: Adolf Pfaff Dr. Karl-Friedrich Reichenbach Gbr vertretungsberechtigter Gesellschafter:; Adolf Pfaff, Waldkirch (DE)

(21) Appl. No.: 12/918,206

(22) PCT Filed: Feb. 11, 2009
(86) PCT No.: PCT/EP2009/000933

§ 371 Date: Aug. 18, 2010

(30) Foreign Application Priority Data
Feb. 21, 2008 (DE) 10 2008 010 408.6

(51) Int. Cl. A61C 5/02

(52) U.S. Cl. 433/81

(57) ABSTRACT

A filling material pin (1) is provided made from a flexible material and is used for filling a root canal (6) of a tooth. The flexible material is memory material, which expands upon heating to the tooth or body temperature in the form of a volume change. The exterior of the filling material pin (1) is profiled at least across the length thereof that is effective in the use position such that regions having both larger and smaller cross-sections alternate in the axial direction, which can be achieved in a particularly useful and simple manner by a helical, threaded, or worm shape of the profiling, which simultaneously pushes an added cement or filling material more effectively and deeper into the canal (6) upon rotating the filling material pin (1) inserted into the root canal (6), thus allowing air contained therein to escape.

### BACKGROUND

The invention relates to a filling material pin made from flexible material for filling a root canal of a tooth, wherein the filling material pin is made from flexible, shape-memory material with a memory effect and this material expands in the form of a volume change when heated to body temperature.

Such a filling material pin is known from DE 10 2005 032 005 B4 and has proved useful.

It has been shown, however, that the stretching of a prefabricated pin made from plastic for generating the memory effect has the result that this pin does not acquire and obtain the desired memory effect across its entire length or that the memory effect is not sufficiently large across the entire length primarily if the starting shape of the pin is conical for adapting to the shape of the root canal, wherein the region of the narrowest cross section is to be arranged, in the position of use, at the depth of the root canal.

From DE 30 38 365 A1, a tooth-pin configuration for mounting in the root canal of a tooth is known that is made essentially from an elongated, metallic body that has a spiral, fine thread on the outside along the entire length. This thread should allow the drilling or cementing of the pin structure in the root canal, wherein the thread should produce additional stability of the seat in the root of the tooth. A feeding effect by the thread for a component to also be introduced into the root canal is not provided. In addition, the body with the thread is not made from shape-memory material with a memory effect.

### SUMMARY

Therefore, there is the objective of creating a filling material pin of the type defined above in which the memory effect has sufficient effectiveness across the entire length and especially also in the region of the larger cross section.

To meet this objective, the filling material pin defined above and made from flexible material producing a memory effect due to stretching is provided such that it has outer profiling at least across its length that can be inserted into the root canal of the tooth or across its entire effective length, wherein, in the case of this profiling, regions of alternating larger and smaller cross sections adjacent one next to the other are provided in the axial direction, wherein at least the sections with the larger cross sections decrease in their cross section in the course of the filling material pin towards its end to be placed at the depth of the root canal such that the profiled filling material pin has a tapering or conical form in some regions or overall and a feeding coil, worm, or thread is formed, in order to feed and/or to compact cement or a root filling paste in the root canal of the tooth.

Relative to a conically tapering filling material pin that is smooth on the outside, it is thus provided that regions of larger and smaller cross sections are adjacent to each other in the axial direction in such a way that these regions of larger and smaller cross sections alternate.

It has been shown that in this way it can be achieved that the memory effect is provided after the stretching of this filling material pin made from plastic across the entire effective length. For the stretching for producing the memory effect, the corresponding extension is transferred due to a tensile force to practically all of the regions present in the direction of longitudinal extension, in particular, with the smaller cross section, so that a corresponding uniform stretching and extension is performed that accompanies a decrease in cross section that is reversible, however, when heated. In addition to the filling material pin having its shape-memory property, it could also be inserted into a correspondingly cleaned root canal and expanded by the heating taking place there, as described in DE 10 2005 032 005 B4. Thus, through expert selection of the profiling and the individual cross sections, the memory effect can be distributed as far across the length of the pin as necessary, so that this memory effect occurs not only in depth at the tip of the root canal, but also close to the outlet of the root canal.

The regions of larger and smaller cross section are thus twisted like a helical line. Here, a single-pitch arrangement is preferred, but the helical shape of the profiling could also have multiple pitches.

Through this construction, it is possible, in the case of stretching, to apply the desired memory effect across the effective length of the pin and to perform a partial rotation about its longitudinal axis when inserting the initially still direct and not re-elongated filling material pin and therefore to feed and/or to compact a cement previously inserted in the root canal or a root filling paste deeper into this root canal and to force out possible air inclusions from this filling. Then, due to the expansion of the filling material pin realized by the heating, the entire compound can be hardened.

Due to the mentioned thread-shaped or spindle-shaped or worm-shaped or coil-shaped profiling of the filling material pin, a double effect could be achieved in that the stretching of such a pin for generating the memory effect is well distributed across the effective or entire length and also the mentioned feeding effect is allowed for the use and the insertion of this filling material pin.

A refinement can provide that the profiling of the filling material pin is also provided in the region of its projection provided in the position of use relative to the tooth and the root canal and is dimensioned so that the projection forms an anchor for a plastic tooth buildup, in particular, made from plastic. In DE 10 2005 032 005 B4 it is described that on the filling material pin disclosed there, an anchor element can be provided for a retention head for a root buildup pin. Through the corresponding dimensioning of the filling material pin profiled according to the invention, the attachment of such a retention head can be avoided and thus a tooth buildup can be simplified.

It is favorable when the cross-sectional dimensions of the regions of small cross section of the filling material pin are equal across a portion of the length or across the entire length of the filling material pin. In the case of a conically tapering filling material pin, this means that the regions of larger cross section, that is, in the case of thread-like profiling, the outer diameter of the thread or the coil or spindle decreases, while the core diameter remains the same. This produces a stable filling material pin in which uniform stretching and thus a memory effect distributed across the entire length is enabled, but the pin can absorb and transmit the tensile forces occurring during stretching essentially uniformly in all longitudinal regions.

Another advantageous construction of the filling material pin according to the invention can provide that a hand grip is provided detachably on the free end of the filling material pin opposite the end that can be placed in the root canal. This hand grip can also be used as a holding head during the stretching and simplifies the handling during the insertion of the filling material pin and for the performance of the already mentioned partial rotation about its longitudinal axis. For the user, it is possible to grip the filling material pin by hand on the hand grip, without the risk that the filling material pin has already begun to expand due to the heat of the hand of the user, because the heat transfer from the grip to the actual filling material pin is low in all cases. The hand grip thus improves handling, simplifies the stretching used for generating the memory effect, and improves the possibility of partial rotation of the filling material pin, in order to generate the feeding effect of the outer thread or the coil to the cement or root filling paste.

The cross section of the hand grip can be larger than that of the filling material pin and can have a polygonal, oval, rounded, or circular construction. Thus it can be easy to grip and can also be used as a holding head during the stretching, wherein, on the opposite end of the filling material pin, an afterward detachable or separable holding element can be connected, in particular, integrally to the pin for this stretching process.

The outside of the hand grip can be roughened and/or provided with knobs or projections. This simplifies gripping this hand grip with only two fingers and simultaneously improves the friction, in particular, between the hand grip and a glove covering the holding finger.

Here, the holding grip could be connected to the filling material pin in the two-component injection method. It could be made from a correspondingly favorable plastic or thermoplastic elastomer and deviate from that of the actual filling material pin with respect to material.

One construction of the invention can provide that a set of several filling material pins is provided made from shape-memory material or from a material producing a memory effect through stretching with different dimensions with respect to the starting diameter and/or length and/or pitch of the profiling. The dentist can then select the most appropriate from the assortment of different filling material pins.

Another construction of the invention can provide that the hand grips of the multiple filling material pins belonging to one set are or can be constructed, shaped, and/or colored differently. Accordingly, the fitting and necessary filling material pin can be selected quickly. Simultaneously, an allocation to the tools with which the root canal is handled before the insertion of the filling material pin can also be achieved, because these tools can have appropriately looking hand grips.

It shall also be mentioned that the feeding coil, worm, or thread forming the outer profiling could be constructed as a left-handed thread. In this way it is possible that a user somewhat turns the pin during insertion in the clockwise direction, which has the result that the filling material is fed deeper into the root canal.

Above all for the combination of individual or multiple of the previously described features and measures, a filling material pin is produced that is made from a plastic shape-memory material whose memory effect can be activated by stretching shortly before insertion into a root canal, so that expansion that allows tight filling of the inner contours of the root canal is then realized when heated. Through the special profiling of the essentially conical filling material pin, the memory effect is achieved across the entire effective length and also correspondingly effective in the region with larger cross section closer to the root canal outlet.

### BRIEF DESCRIPTION OF THE DRAWINGS

Below, embodiments of the invention are described in detail with reference to the drawing. Shown, in part, in schematic diagrams are:

FIG. 1 a side view of a worm-shaped, profiled filling material pin according to the invention with a hand grip and with a holding element arranged on the opposite end for stretching to be performed for generating the memory effect,

FIG. 2 a partial longitudinal section view according to the arrows A-A in FIG. 1 and in FIG. 5,

FIG. 3 a cross sectional view according to line B-B in FIG. 1 and FIG. 5,

FIG. 4 a front view taken in the direction of the arrow C in FIGS. 1 and 5,

FIG. 5 a view of an embodiment modified accordingly from FIG. 1 of a filling material pin according to the invention with thread-like profiling with greater depth than in the embodiment according to FIG. 1,

FIG. 6 a longitudinal section view through a tooth with a defect in the crown region and with widened root canal and filling material pin inserted therein before its expansion,

FIG. 7 a longitudinal section view of the tooth according to FIG. 6 with the in-between expanded filling material pin and a tooth stump made from plastic and built-up above the tooth,

FIG. 8 a view corresponding to FIG. 6 for a tooth that is not built up and still has its biting surface,

FIG. 9 a top view of the tooth according to FIG. 8 after the separation of the projection of the filling material pin,

FIG. 10 a view corresponding to FIG. 8 in a modified embodiment in which the filling material pin has a thread-like profiling,

FIG. 11 a top view of the tooth according to FIG. 10 after the removal of the projection of the expanded filling material pin,

FIG. 12 a longitudinal section view of a tooth with expanded filling material pin according to FIG. 10 and filling located above this pin in the end region of the root canal.

### DETAILED DESCRIPTION OF THE PREFERRED EMBODIMENTS

In the following description of different embodiments, parts matching in function are given matching reference numbers even for different forms or constructions.

A filling material pin designated as a whole with 1 and made from flexible material is used, in the case of root-canal surgery on the root canal 6 of a tooth, for its filling, wherein it interacts with cement or a root filling paste introduced into the root canal 6.

In the different embodiments still to be explained below, the filling material pins 1 have an essentially continuous conical shape and are made from flexible, shape-memory material made from plastic that obtains its shape-memory property through a stretching process and are adapted with respect to their length and their outer contours approximately to the contours of the root canal 6. The shape-memory material can be adjusted so that it expands for temperatures greater than 30°, that is, the filling material pin 1 is expanded above this temperature. Preferably, the filling material pins 1 are stretched only shortly before their use or else stored cooled in the stretched starting position.

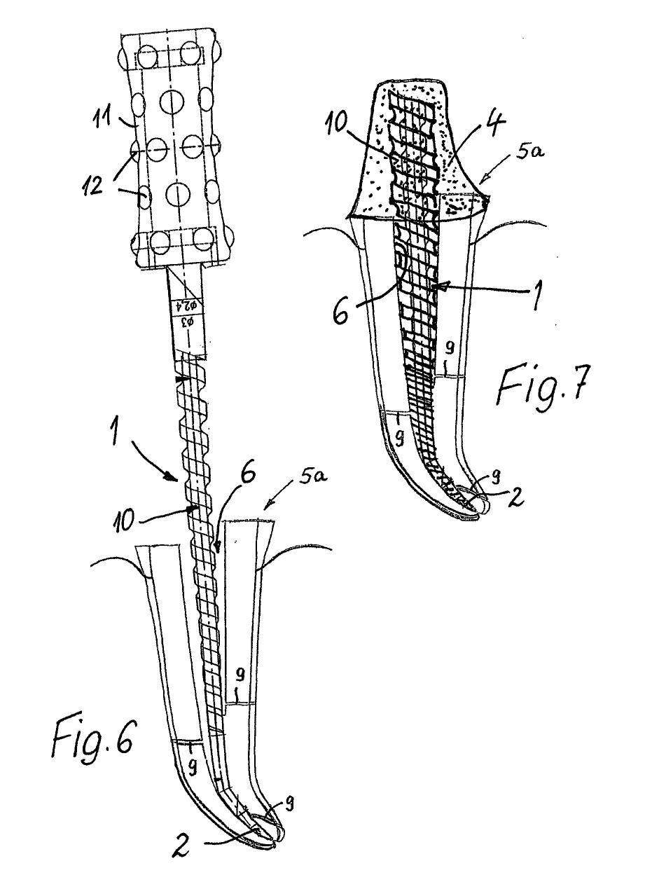

For larger tooth defects, the filling material pins 1 can be inserted when it is necessary to build up a plastic tooth stump 4 over which a crown is then placed, as will be explained below with reference to FIGS. 6 and 7.

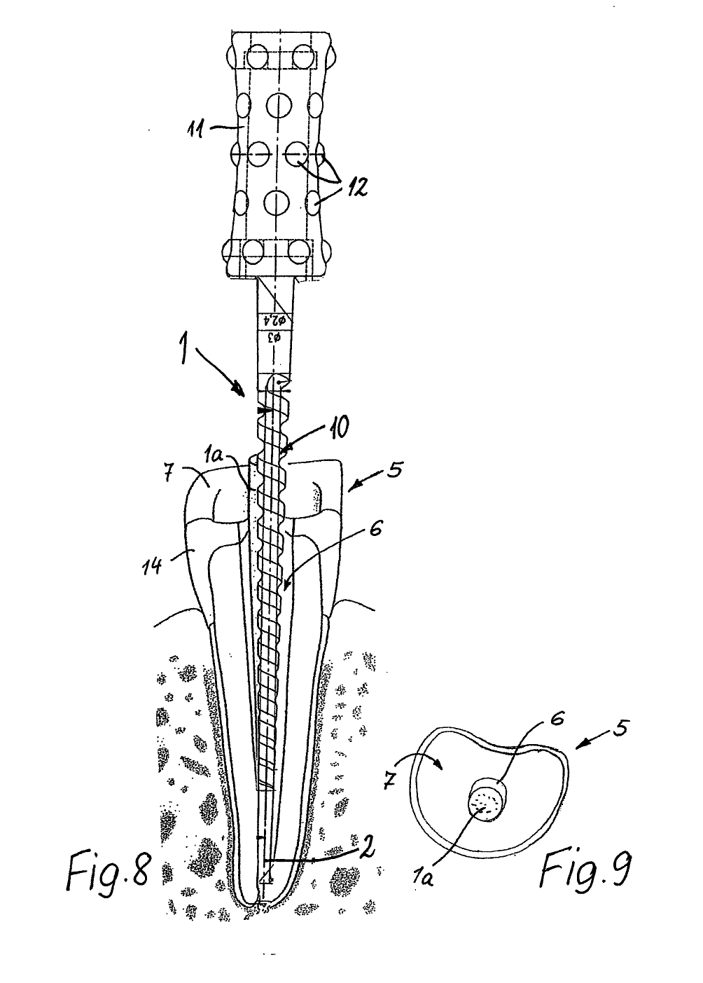

The filling material pin 1, however, could also then be used when, after a root-canal surgery, only a filling of the inlet cavity, for example, with plastic or a similar filling material is necessary, as is explained with reference to FIGS. 8 to 12.

Comparable arrangements are described in DE 10 2005 032 005 B4, on one hand, with reference to FIGS. 11 to 15 and, on the other hand, with reference to FIGS. 5 to 9.

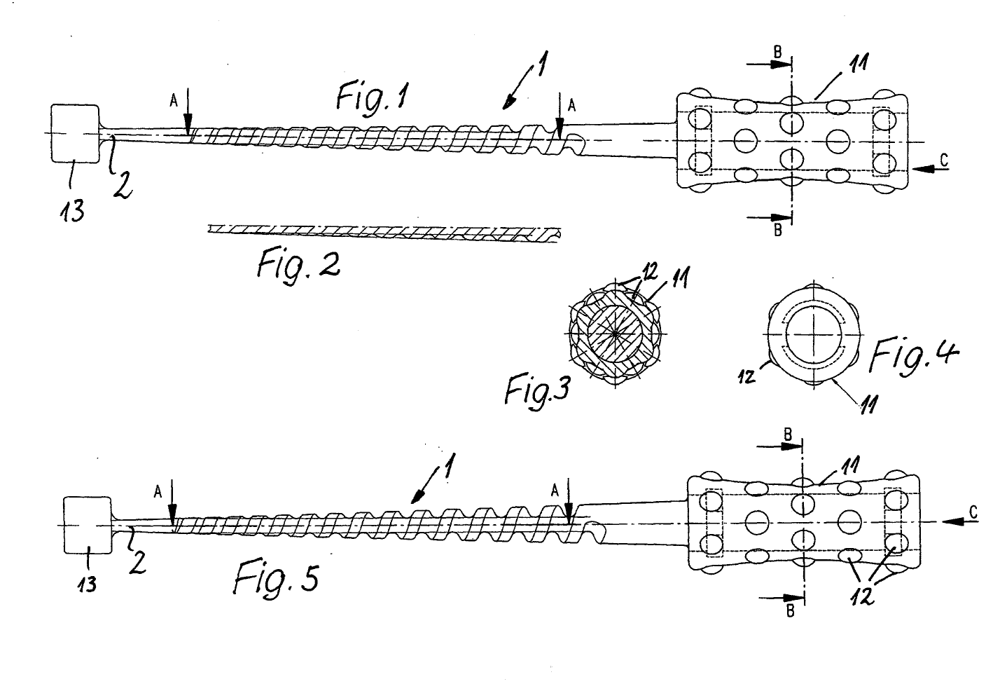

With reference to FIGS. 1 to 8 and 10 it becomes clear that the somewhat differently dimensioned or constructed filling material pins 1 have outer profiling across the length that can be inserted into the corresponding root canal 6 of the tooth, wherein, in the case of this profiling—generally expressed—regions of alternating larger and smaller cross sections are provided adjacent to each other in the axial direction, that is, regions of larger and smaller cross sections alternate. Simultaneously, it becomes clear that the sections and regions with the larger cross sections decrease in their cross section in the course of the filling material pin 1 towards its end 2 to be placed at the depth of the root canal 6 and thus the profiled filling material pin 1 has the already mentioned tapering or conical shape.

Through this “jagged” profiling of the outside of the filling material pin 1, the memory effect could be produced after a stretching of this filling material pin 1 made from plastic across its effective length, so that, within the root canal 6, an essentially uniform expansion or widening can take place that leads to its filling together with a cement or filling paste due to the conicality of the filling material pins 1.

The previously mentioned profiling of the outside of the filling material pins has a worm-shaped or coil-shaped or thread-shaped construction in the embodiments, that is, the regions of larger and smaller cross section are twisted like a helical line in the axial direction across the profiled region of the filling material pin 1, wherein, in the embodiments according to FIGS. 1, 5, and 10, one-pitch threads or helical lines are provided.

With reference to FIGS. 6 and 7 it becomes clear that the helical-line like or worm-like profiling is also provided in the region of its projection 10 provided in the position of use relative to the tooth 5 or a residual tooth 5a and the root canal 6 and is dimensioned so that this projection 10 also forms, due to its profiling, an anchor for a plastic tooth buildup of a tooth stump 4 made from plastic. This arrangement with the tooth stump 4 built up on a residual tooth 5a can be seen especially well in FIG. 7. Simultaneously, with reference to FIG. 6 it becomes clear that here, initially, a filling material pin 1 was inserted in the stretched, not-yet-expanded state into the root canal 6 of the residual tooth 5a up to the depth of the root canal 6, after which it is expanded and separated at the already mentioned projection 10 relative to the residual tooth 5a, so that the tooth stump 4 can then be built up and fixed or anchored to the profiled projection 10.

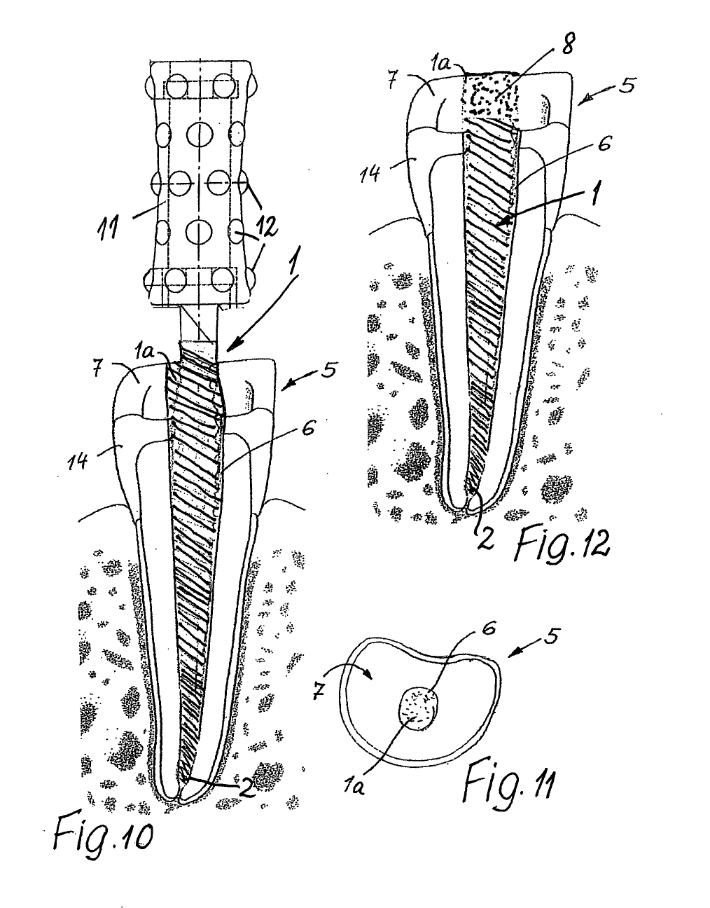

In FIGS. 8 to 12, in contrast, the treatments of a still complete tooth 5 in the region of its root canal 6 with differently shaped filling material pins 1 are shown. FIG. 8 shows an arrangement in which a filling material pin according to FIG. 1 or 5 is inserted, while FIGS. 10 and 12 show a filling material pin with a thread-like profiling. FIG. 12 here shows simultaneously that the filling material pin 1 is separated somewhat analogous to FIG. 9 from DE 10 2005 032 005 B4 after its expansion and the filling of the root canal 6 within the tooth crown 14 and the end of the filling material pin 1 located above this is removed, so that the upper end of the root canal 6 or the inlet cavity for a plastic filling 8 is free and is used for a plastic filling 8 that ends flush at the surface 1a.

In the comparison of FIGS. 1 and 5, one sees that the thread pitches of the worm-like profiles can be shaped with different depths, in order to be able to fill root canals 6 having, in particular, also different cross-sectional dimensions. Here, it simultaneously becomes clear from FIGS. 1, 2, and 5 that the cross-sectional dimensions of the regions of small cross section, that is, the cross section of the core diameter of the corresponding worm or coil remains the same across the entire length of the profiling, that is, this core has no conical shape and does not taper, while the outer worm or thread pitches decrease and taper toward the end 2 to be placed at the depth of the root canal 6.

In FIGS. 1, 5, 6, 8, and 10, one also sees that a hand grip 11 is provided detachably on the free end of the filling material pin 1 opposite the end 2 that can be placed in the root canal 6, wherein the detachability is made illustrated primarily through the comparison of FIGS. 10 and 12. This has a greater cross section than the actual filling material pin 1 and is provided in the embodiment according to FIGS. 3 and 4 with a somewhat circular cross section, but carries on the outside knobs or projections 12 that increase the grip. This hand grip 11 can be connected, for example, in the two-component injection method, to the appropriate filling material pin 1, in order to allow a material different relative to filling material pin 1. Due to its dimensions, it can be easily gripped and reduces or prevents premature heat transfer from the fingers of the user to the filling material pin 1 that can be expanded by heat.

It is given from FIGS. 1 and 5, as well as other figures, that a set of multiple filling material pins 1 made from shape-memory material with different dimensions with respect to starting diameter and/or length and/or pitch of the profiling is provided, wherein the hand grips 11 of the multiple filling material pins 1 belonging to one such set are or can be constructed, shaped, and/or optionally also colored differently, in order to be able to be selected quickly and to be able to relate to the processing of the root canal 6 with associated tools.

The outer profiling has a coil-like, worm-like, or thread-like construction in the embodiments and can preferably increase like a left-handed thread, in order to feed and press cement located in the root canal 6 or a filling paste through rotation in the clockwise sense deeper and tighter into the root canal 6 and to better fill and seal possible side canals 9 and to drive out air residue, during the rotational movement during insertion of this filling material pin 1. At the end 2, a holding element 13 is provided that can be used as a counter holder during the stretching of the filling material pin 1 and can be separated after the stretching.

After the introduction of the filling material pin 1 in a root canal 6 according to FIG. 6, 8, or 10 and the associated displacement of previously inserted cement or similar filling paste, the filling material pin 1 could be slightly rotated, wherein the mentioned filling paste or the cement is pressed deeper and into hollow cavities and side canals 9 of the root canal 6, after which the shape-memory material of the filling material pin 1 is heated by the ambient heat prevailing in the root canal 6 and is therefore expanded, as is shown in FIGS. 10 and 12, and also applies for the embodiments according to FIGS. 6 and 8, at least after a certain time. Therefore, the outer extent of the filling material pin 1 contacts the inner wall of the root canal 6 and filling paste or cement is likewise displaced and compacted, so that the root canal 6 is filled to the best possible extent. Because the filling material pin 1 has the described profiling, the memory effect is produced across the entire effective length, so that the widening in the root canal is also realized at the region close to the outlet of the root canal 6. In the case of residual teeth 5a, the outer profiling allows a projection 10 to be formed that can be used for holding a built-up tooth stump 4 that is made from plastic material and can be used, on its side, as a foundation for a crown.

The filling material pin 1 is made from flexible material and is used for filling a root canal 6 of a tooth, wherein the flexible material is shape-memory material that expands in the form of a volume change when heated to tooth or body temperature. The outside of the filling material pin 1 is profiled at least across its effective length in the position of use such that, in the axial direction, regions of larger and smaller cross sections alternate, which can be achieved in an especially useful and simple way by a coil, thread, or worm shape of the profiling that simultaneously presses a filled cement or filling material even better and deeper into the canal 6 when the filling material pin 1 inserted into the root canal 6 is rotated and causes air contained therein to be discharged.

1. Filling material pin (1) comprising a flexible material for filling a root canal (6) of a tooth, the flexible material is a flexible, shape-memory material with a memory effect and the material expands with a volume change when heated to body temperature, outer profiling is located at least across a length of the filling material pin (1) that can be inserted into the root canal (6) of a tooth or across an entire effective length, the profiling includes regions of alternately larger and smaller cross sections provided one adjacent to the other in an axial direction, wherein at least the regions with the larger cross sections decrease in cross section toward an end (2) that can be placed in the root canal (6) such that the profiled filling material pin (1) has a tapering or conical shape in some regions or overall and a feed coil, worm, or thread is formed, in order to feed, compact or feed and compact cement or a root filling paste in the root canal (6) of the tooth.

2. Filling material pin according to claim 1, wherein the memory effect is provided after stretching the filling material pin (1) that is made from plastic across the entire effective length.

3. Filling material pin according to claim 1, wherein the profiling is also provided in a region of its projection (10) provided in the position of use relative to the tooth (5, 5a) and the root canal (6) and is dimensioned so that the projection (10) is adapted to form an anchor for a plastic tooth buildup.

4. Filling material pin according to claim 1, wherein cross-sectional dimensions of the regions of smaller cross section of the filling material pin (1) are equal across a part of the length or across the entire length.

5. Filling material pin according to claim 1, wherein a hand grip (11) is provided detachably on an end of the filling material pin (1) opposite the end (2) that can be placed in the root canal (6).

6. Filling material pin according to claim 5, wherein a cross section of the hand grip (11) is larger than that of the filling material pin (1) and has a polygonal, oval, rounded, or circular construction.

7. Filling material pin according to claim 6, wherein an outside of the hand grip (11) is at least one of roughened or provided with knobs or projections (12).

8. Filling material pin according to claim 6, wherein the hand grip (11) is connected in a two-component injection method to the filling material pin (1).

9. Filling material pin according to claim 6, wherein a set of several filling material pins (1) made from shape-memory material is provided with the filling material pins of the set having different dimensions with respect to at least one of a starting diameter or length or pitch of the profiling.

10. Filling material pin according to claim 9, wherein the hand grips (11) of the multiple filling material pins (1) belonging to one set are at least one of configured, shaped, or colored differently.

11. Filling material pin according to claim 1, wherein the feed coil, worm, or thread forming the profiling is constructed as a left-handed thread.
